(19) United States
(12) Patent Application Publication
(10) Pub. No.: US 2007/0292755 A1
(43) Pub. Date: Dec. 20, 2007

(54) Button Alkaline Battery Cell

(76) Inventor: Kam Wah Wilson Ip, Hongkong (CN)

Correspondence Address: BAKER DONELSON BEARMAN CALDWELL & BERKOWITZ, PC, 555 11TH STREET, NW, 6TH FLOOR, WASHINGTON, DC, 20004, US

(21) Appl. No.: 10/579,532

(22) PCT Filed: Dec. 30, 2004
(86) PCT No.: PCT/CN04/01581

§ 371 Date: May 16, 2006

(30) Foreign Application Priority Data
Dec. 2, 2004 (CN) 200420116760.0

(51) Int. Cl. H01M 2/08; H01M 6/06; H01M 6/12

(52) U.S. Cl. 429/209

(57) ABSTRACT

A Hg-free button alkaline battery cell comprising: anode shell, cathode cap, anode mixture and cathode mixture. Said cathode cap has outward flange. Separator lies between the anode mixture and the cathode mixture, and gasket with bottom and outer wall places on the separator. The open-end portion of said anode and the upper end portion of the outer wall of the gasket are bent to the cathode cap, the upper end portion of the outer wall of the gasket fastened on the flange of the cathode cap and leaning against the outer surface of the cathode cap; sealant layer is filled in the interspace between the flange of the cathode cap and the bottom and outer wall of the gasket. The cell of the present invention is sealed by the sealant layer, which can prevent electrolyte from leakage and reduce the difficulty of the process.

### FIELD OF THE INVENTION

This invention relates to button alkaline battery cells, and more particularly to the button alkaline cells used for mini electron devices such as electronic watch, electronic table calculator and so on.

### BACKGROUND OF THE INVENTION

In the prior art, the button alkaline battery cells are fabricated as follows:

Referring to FIG. 1, anode shell 1 contains anode mixture 4 comprising manganese dioxide as active materials. Cathode cap 2 comprises iron as substrate, and plated nickel on the outer layer and plated indium, tin or copper on the inner layer. These are assembled with a gasket (insulated ring). The cathode cap 2 contains cathode mixture 5 comprising Hg-free zinc powders or zinc alloy powers as active materials. Separator 6 separates the anode mixture 4 and cathode mixture 5. The button cell is injected with alkaline electrolyte, and is sealed using a pressing machine with a specialized sealing mould.

Hydrogen gas is generated during storage of button cells of the above general type which uses cathode mixture containing Hg-free zinc or zinc alloy. The hydrogen causes the increase of the inner cell pressure and electrolyte leakage. Although such problem can be prevented by the use of cathode mixture containing zinc amalgam, mercury use must is restricted for reasons of environment protection. Therefore, there is a need for Hg-free and leak-proof button alkaline cells, and methods for their manufacture.

### SUMMARY OF THE INVENTION

Accordingly, the object of the present invention is to provide an Hg-free (and leak-proof) button alkaline cell.

In accordance with an embodiment of the present invention, a button alkaline battery cell comprises anode shell, cathode cap, anode mixture, cathode mixture, said cathode cap having outwardly-turning flanges, a separator between the anode mixture and the cathode mixture, and a gasket with a bottom and outer wall on the separator. The button cell further comprises a separation covering (or separation layer) which is attached to the inner wall of the cathode cap. The shape of said separation covering (or separation layer) corresponds to the shape of the inner wall of the cathode cap, the bottom of the separation covering being fastened to the bottom of the gasket. The bottom of the separation covering and the outer walls of the gasket form a groove, in which the flange of the cathode cap is contained. Sealant layer is filled in the interspace between the flange of the cathode cap and the separation covering, and the bottom and outer wall of the gasket.

Compared with the prior art, the button alkaline cells of the present invention uses a sealant layer, which effectively prevents alkaline electrolyte of the cells from leakage. Further, during the manufacturing process, it is not necessary to bend the open-end portion of the anode shell to increase the compression of the gasket so as to obtain a satisfactory sealing against electrolyte leakage. Instead, the edge of the open-end portion of the anode shell and the upper end portion of the outer wall of the gasket are bent to the cathode cap, the upper end portion of the outer wall of the gasket is fastened on the flange of the cathode cap and tightly pressed against the outer surface of the cathode cap. Consequently, the bottom of the flange of the cathode cap is not distorted to bend toward the center of the cell during assembly, resulting in reduced manufacturing.

### BRIEF DESCRIPTION OF THE FIGURES

FIG. 1 is a schematic depiction of a button alkaline battery cell of the prior art.

FIG. 2 is a schematic depiction of a gasket of the present invention.

FIGS. 3 and 4 show assembled gasket and cathode cap.

FIGS. 5 and 6 show a button alkaline battery cell of the present invention.

FIG. 7 is a schematic depiction of a separation covering (or separation layer) according to another embodiment of the present invention.

FIG. 8 shows the assembled the separation covering (or separation layer) and the cathode cap according to another embodiment of the present invention.

FIG. 9 shows the assembled the separation covering (or separation layer), the cathode cap and the gasket according to another embodiment of the present invention.

FIG. 10 is a schematic depiction of a button alkaline battery cell according to another embodiment of the present invention.

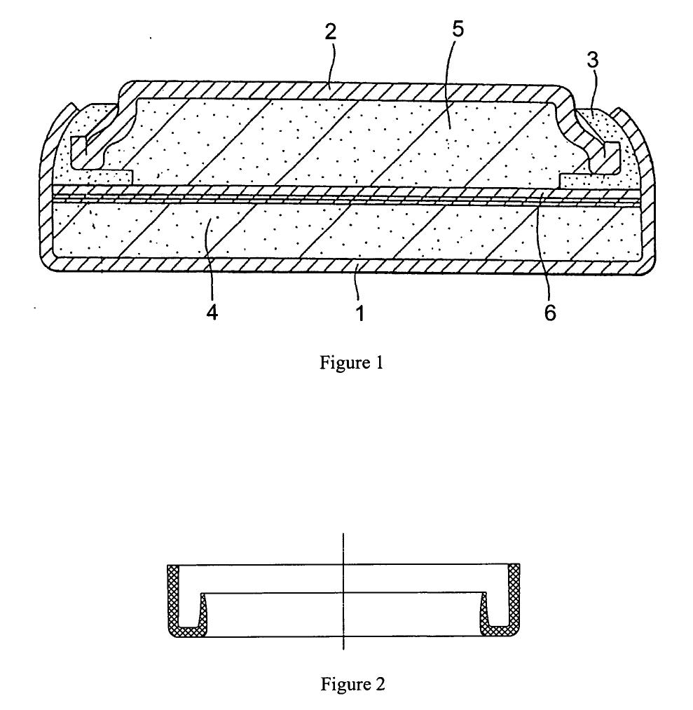

### DETAILED DESCRIPTION OF THE INVENTION

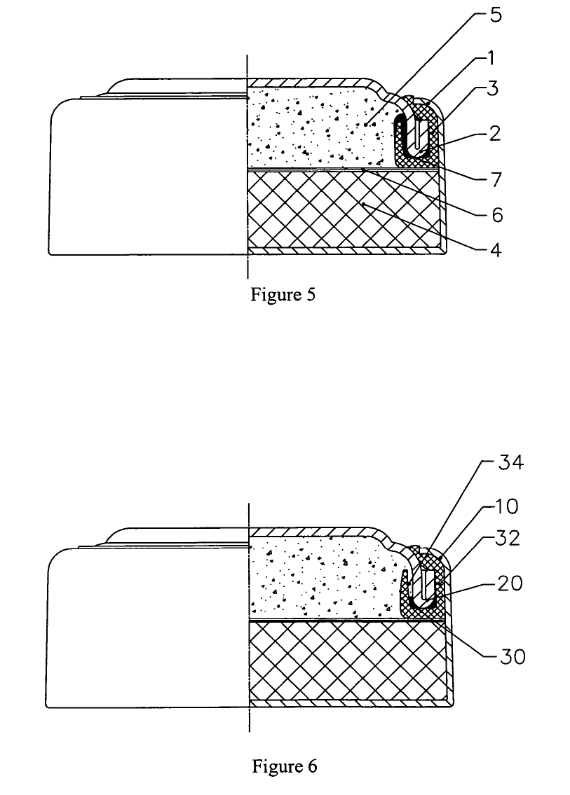

Referring to FIGS. 5 and 6, there is shown a button alkaline button cell according to the present invention comprising an anode shell 1 filled with anode mixture 4 and a cathode cap 2 filled with cathode mixture 5, separator 6 lying between the anode mixture 4 and the cathode mixture 5, gasket 3 placed on the separator 6.

Said gasket 3 comprises a bottom, inner wall 30 and outer wall 32, which are combined to form a groove 34. The thickness of the inner wall 30 decreases along its upward direction. (This technical characteristic differs from that mentioned before.)

Said cathode cap 2 has outward U-shaped flange 20, located in the groove 34 of the gasket 3. The open-end portion 10 of said anode shell 1 and the upper end portion of the outer wall 32 of the gasket 3 are bent to the cathode cap 2, the upper end portion of the outer wall 32 of the gasket 3 fastened on the U-shaped flange 20 of the cathode cap 2 and leaning against the outer surface of the cathode cap 2.

Sealant layer 7 is filled in the interspace between the U-shaped flange 20 of the cathode cap 2 and the inner wall 30, bottom, outer wall 32 of the gasket 3 to prevent electrolyte from leakage. The sealant layer 7 is made of epoxy resin.

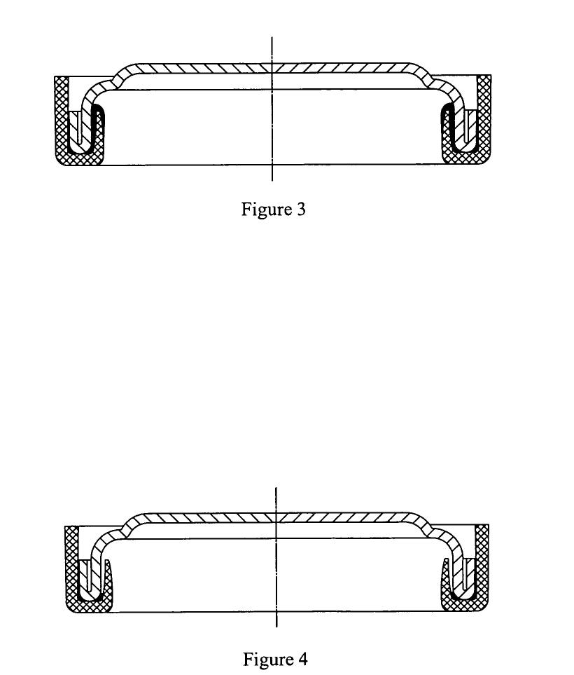

Referring to FIG. 2 to FIG. 6, the cell is assembled as follows: First, gasket 3 is provided; the sealant is injected into the groove 34 of the gasket 3; then the cathode cap 2 is assembled, which is filled with cathode mixture 5, said cathode mixture 5 comprising the slurry of Hg-free zinc powder mixture.

The anode shell 1 is filled with anode mixture 4, which is manganese dioxide mixture. The mixture is pressed as cake shape, then two separators 6 is positioned on the surface of the mixture, then the alkaline electrolyte is injected.

The cathode cap 2 is assembled with the anode shell 1 by facing the cathode mixture 5 to the separator 6, then the cell is sealed by being punched in the specific sealing mould, the open-end portion 10 of said anode shell 1 and the upper end portion of the outer wall 32 of the gasket 3 are bent to the cathode cap 2, the upper end portion of the outer wall 32 of the gasket 3 fastened on the U-shaped flange 20 of the cathode cap 2 and leaning against the outer surface of the cathode cap 2.

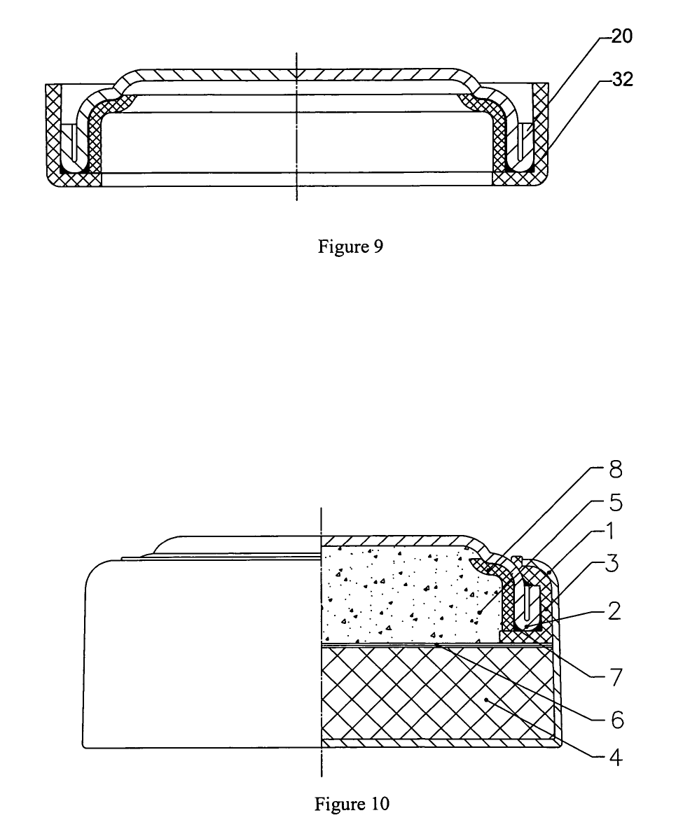

Referring to FIG. 9 and FIG. 10, another embodiment of the present invention comprises a anode shell 1 and a cathode cap 2. The anode shell 1 is filled with anode mixture 4, the cathode cap 2 comprises a separation covering (or separation layer), and is filled with cathode mixture 5. Separator 6 lies between the anode mixture 4 and the cathode mixture 5, and gasket 3 is placed on the separator 6.

Said gasket 3 comprises bottom and outer wall 32.

Said cathode cap 2 has outwardly U-shaped flange 20. The open-end portion 10 of said anode shell 1 and the upper end portion of the outer wall 32 of the gasket 3 are bent to the cathode cap 2, the upper end portion of the outer wall 32 of the gasket 3 fastened on the U-shaped flange 20 of the cathode cap 2 and leaning against the outer surface of the cathode cap 2.

The separation covering (or separation layer) 8 is attached to the inner wall of the cathode cap 2. The shape of said separation covering (or separation layer) 8 corresponds with the shape of the inner wall of the cathode cap 2, the bottom of the separation covering is fastened to the bottom of the gasket 3, and combined with the bottom and the outer wall 32 of the gasket 3 to form a groove. The U-shape flange 20 of the cathode cap 2 is located in the groove. Sealant layer 7 is filled in the interspaces between the U-shaped flange 20 of the cathode cap 2, the separation covering (or separation layer) 8 and the bottom and outer wall 32 of the gasket 3 to prevent electrolyte from leakage. The sealant layer 7 is made of epoxy resin.

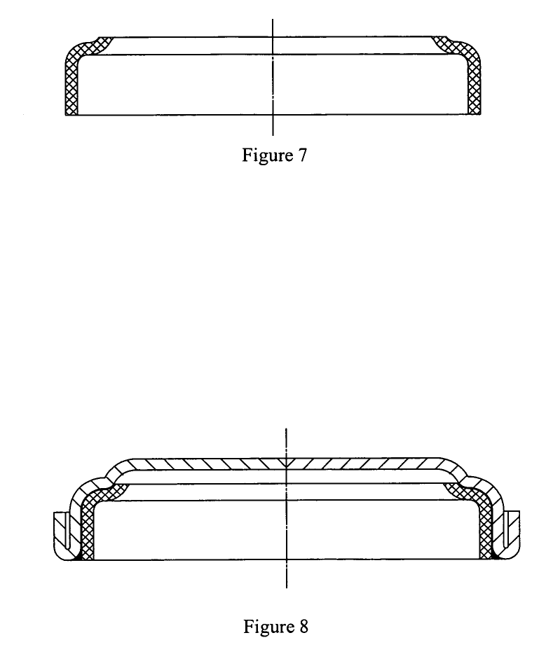

Referring to FIG. 7 to FIG. 10, the cell is assembled as follows: First, the cathode cap 2 is provided; the separation covering (or separation layer) 8 is attached to the inner wall of the cathode cap 2 by sealant; a sealant layer 7 is coated on the bottom of the separation covering (or separation layer) 8 and the bottom of the U-shaped flange of the cathode cap 2, which then is located in the gasket 3; the cathode cap is filled with cathode mixture 5, said cathode mixture 5 comprising the slurry of the Hg-free zinc powder mixture.

The rest assembling is identical with that of the Example 1.

The L736 (LR41) cells are made according to the said Hg-free button alkaline cells. The shelf performances of the cells shelved at 45° C. and 90% relative humidity and at 60° C. and 90% relative humidity respectively are shown as follows:

| | Leakage rate shelved at | | | | | Height (mm) change |
|---|---|---|---|---|---|---|
| | 45° C. and 90% RH | | | | | shelved at 45° C. |
| | 20 | 30 | 40 | 50 | 60 | for 60 days |
| | days | days | days | days | days | 60 days |
| Example 1 | 0 | 0 | 0 | 0 | 0 | 0.006 |
| Example 2 | 0 | 0 | 0 | 0 | 0 | 0.005 |
| The prior | 0 | 0 | 0 | 0 | 0 | 0.006 |
| art | | | | | | |

| | |
|---|---|
| | Height (mm) change |
| Leakage rate shelved at | shelved at 60° C. |
| 60° C. and 90% RH | for 28 days |

| | 14 days | 28 days | 28 days |
|---|---|---|---|
| Example 1 | 0 | 0 | 0.006 |
| Example 2 | 0 | 0 | 0.005 |
| The prior art | 0 | 10 | 0.006 |

It can be obtained from the results that using the gasket 3 and the sealant layer 7 filled in the interspaces can reduce the electrolyte leakage to realize the anticipated Hg-free and leak-proof button alkaline cells.

In the state of the prior art, during the process of extruding inwardly the open-end portion of the anode, when the open-end portion of the anode is bent along the radius direction of the cell to further increase gasket shrinkage so as to keep a satisfied resistance against electrolyte leakage; the compression force of the gasket on the cathode cap is also increased, which often causes the flange of the cathode cap distorted to the center of the cell. For this reason, it is impossible to obtain the needed compression of the gasket to keep the satisfied resistance against electrolyte from leakage, so the resistance keeping electrolyte against leakage decreases, and the electrolyte is easy to be leaked. The cell of the present invention is sealed by the sealant layer 7. During the process, it is not necessary to bend the open-end portion 10 of the anode shell 1 to further increase gasket 3 shrinkage so as to keep the satisfied resistance of preventing electrolyte from leakage, instead, the open-end portion 10 of the anode shell 1 and the upper end portion of the outer wall 32 of the gasket 3 are bent to the cathode cap 2, the upper end portion of the outer wall 32 of the gasket 3 fastened on the flange 20 of the cathode cap 2 and leaning against the outer surface of the cathode cap 2. The bottom of the flange 20 of the cathode cap 2 is not distorted to the center of the cell in the process, which also reduces the difficulty of the process.

While the present invention has been described in detail with reference to the preferred embodiments, those skilled in the art will appreciate that various modifications and substitutions can be made thereto without departing from the spirit and scope of the present invention as set forth in the appended claims.

1. A button alkaline battery cell comprising an anode shell containing an anode mixture, said anode shell being interlocked with a cathode cap containing a cathode mixture, said cathode cap having outward flange, a separator between the anode mixture and the cathode mixture, a gasket fastened on the outward flange, wherein said gasket has a bottom and an outer wall and is placed on the separator, wherein an open-end portion of said anode and an upper end portion of the outer wall of the gasket are bent to the cathode cap, the upper end portion of the outer wall of the gasket is pressed against the outer surface of the cathode cap; and wherein a sealant layer is filled in an interspace formed between the flange of the cathode cap and the gasket.

2. The button alkaline battery cell according to claim 1, wherein said gasket further comprises an inner wall, the bottom, the inner wall and the outer wall of the gasket form a groove, the flange of the cathode cap is located in the groove of the gasket, and a sealant layer is filled in the interspace between the flange of the cathode cap and the bottom, the inner wall, the outer wall of the gasket.

3. The button alkaline battery cell according to claim 2, wherein the thickness of the inner wall of the gasket decreases along its upward direction.

4. The button alkaline battery cell according to claim 1, wherein said button alkaline battery cell further comprises a separation layer attached to the inner wall of the cathode cap, the shape of said separation layer corresponding with the shape of the interior of the cathode cap, wherein the bottom of the separation layer is fastened to the upper side of the bottom of the gasket, and forms a groove with the bottom and the outer wall of the gasket; and wherein the flange of the cathode cap is located in the groove, which is filled with a sealant layer.

5. The button alkaline battery cell according to claim 1, wherein said flange of the cathode cap is U-shaped.

6. The button alkaline batter cell according to claim 1, wherein the sealant comprises epoxy resin.
